(19) United States
(12) Patent Application Publication
(10) Pub. No.: US 2013/0009595 A1
(43) Pub. Date: Jan. 10, 2013

(54) DEVICES FOR RECEIVING PERIODIC CHARGING

(76) Inventor: KEVIN L. BROWN, Reston, VA (US)

(21) Appl. No.: 13/544,337

(22) Filed: Jul. 9, 2012

Related U.S. Application Data
(60) Provisional application No. 61/505,862, filed on Jul. 8, 2011.
(60) Provisional application No. 61/505,855, filed on Jul. 8, 2011.
(60) Provisional application No. 61/505,842, filed on Jul. 8, 2011.
(60) Provisional application No. 61/548,455, filed on Oct. 18, 2011.
(60) Provisional application No. 61/577,977, filed on Dec. 20, 2011.
(60) Provisional application No. 61/635,441, filed on Apr. 19, 2012.
(60) Provisional application No. 61/668,662, filed on Jul. 6, 2012.

(51) Int. Cl. H02J 7/00

(52) U.S. Cl. 320/108

(57) ABSTRACT

An apparatus for an energy storage device configured to store electrical energy received from a source. The energy storage device is configured to store the electrical energy received from the source via one or more temporary circuits created through the energy storage device and the source while the energy storage device and the source are moving relative to one another.

### RELATED CASES

This application claims the benefit of U.S. Provisional Application No. 61/505,862 filed on 8 Jul. 2011, U.S. Provisional Application No. 61/505,855 filed on 8 Jul. 2011, U.S. Provisional Application No. 61/505,842 filed on 8 Jul. 2011, U.S. Provisional Application No. 61/548,455 filed on 18 Oct. 2011, U.S. Provisional Application No. 61/577,977 filed on 20 Dec. 2011, U.S. Provisional Application No. 61/635,441 filed on 19 Apr. 2012, and U.S. Provisional Application No. 61/668,662 filed on 6 Jul. 2012, the contents of which are all incorporated by reference.

### TECHNICAL FIELD

This disclosure relates to devices for receiving periodic charging.

### BACKGROUND

Energy storage devices, such as batteries, may be used to provide power to electronic devices (e.g., personal computers, laptop computers, smart phones, notebook computers, tablets, power tools, etc.) as well as vehicles (e.g., cars, motorcycles, trains, busses, air planes, helicopters, etc.). However, the use of the energy storage devices suffers numerous disadvantages.

### SUMMARY OF DISCLOSURE

In one implementation, an apparatus comprises an energy storage device configured to store electrical energy received from a source. The energy storage device is configured to store the electrical energy received from the source via one or more temporary circuits created through the energy storage device and the source while the energy storage device and the source are moving relative to one another.

One or more of the following features may be included. The energy storage device may include at least one of one or more capacitors, one or more chemical energy storage devices, one or more inductive energy storage devices, one or more electro-mechanical energy storage devices, one or more electro-pneumatic storage devices, one or more electro-hydraulic storage devices, and one or more batteries. One or more switches may be operatively connected to the energy storage device. The one or more switches may be configured to switch the one or more temporary circuits into and out of electrical contact with the source while the energy storage device and the source are moving relative to one another. The one or more temporary circuits may be sequentially made and then may be sequentially broken while the energy storage device and the source are moving relative to one another. The timing of the sequentially made and sequentially broken one or more temporary circuits, while the energy storage device and the source are moving relative to one another, may result in at least one of an increasing and decreasing energy level over time of the energy storage device. An amount of the electrical energy received from the source may be based upon, at least in part, at least one of one or more preset parameters and one or more time-varying parameters. The one or more preset parameters and the one or more time-varying parameters may include at least one of an estimate of an initial charge state of the energy storage device, a speed of the energy storage device moving by at least one of the source and a second source, a future distance between at least one of the source and a second source, and a future time between the energy storage device moving by at least one of the source and a second source.

The one or more temporary circuits created through the energy storage device and the source while the energy storage device and the source are moving relative to one another may be created in response to a contactless interaction between, at least in part, the energy storage device and the source. The one or more temporary circuits created through the energy storage device and the source while the energy storage device and the source are moving relative to one another may be created in response to a mechanical contact between, at least in part, the energy storage device and the source. A second energy storage device may be operatively connected to the energy storage device. The second energy storage device may be configured to automatically connect in at least one of series and parallel with the energy storage device when the energy storage device contains insufficient electrical energy to power a load. A switch may be configured to switch the energy storage device to match an impedance to a load in response to a slowing movement of the energy storage device.

In another implementation, an apparatus comprises a capacitor configured to store electrical energy received from a charging station. The capacitor is configured to store the electrical energy received from the charging station via one or more temporary circuits created through the capacitor and the charging station while the capacitor and the charging station are moving relative to one another.

One or more of the following features may be included. The capacitor may include at least one of one or more electrostatic capacitors, one or more super capacitors, and one or more ultra capacitors. One or more switches may be operatively connected to the capacitor. The one or more switches may be configured to switch the one or more temporary circuits into and out of electrical contact with the charging station while the capacitor and the charging station are moving relative to one another. The one or more temporary circuits may be sequentially made and then may be sequentially broken while the capacitor and the charging station are moving relative to one another. The timing of the sequentially made and sequentially broken one or more temporary circuits, while the capacitor and the charging station are moving relative to one another, may result in at least one of an increasing and decreasing energy level over time of the capacitor. The amount of the electrical energy received from the charging station may be based upon, at least in part, at least one of one or more preset parameters and one or more time-varying parameters. The one or more preset parameters and the one or more time-varying parameters may include at least one of an estimate of an initial charge state of the capacitor, a speed of the capacitor moving by at least one of the charging station and a second charging station, a future distance between at least one of the charging station and a second charging station, and a future time between the capacitor moving by the charging station.

The one or more temporary circuits created through the capacitor and the charging station while the capacitor and the charging station are moving relative to one another may be created in response to a contactless interaction between, at least in part, the capacitor and the charging station. The one or more temporary circuits created through the capacitor and the charging station while the capacitor and the charging station are moving relative to one another may be created in response to a mechanical contact between, at least in part, the capacitor and the charging station.

A second capacitor may be operatively connected to the capacitor. The second capacitor may be configured to automatically connect in at least one of series and parallel with the capacitor when the capacitor contains insufficient electrical energy to power a load. A switch may be configured to switch the capacitor to match an impedance to a load in response to a slowing movement of the capacitor.

In another implementation, an apparatus comprises at least one of a vehicle and an appliance operatively connected to an energy storage device configured to store electrical energy received from a source. The energy storage device is configured to store the electrical energy received from the source via one or more temporary circuits created through the energy storage device and the source while the energy storage device and the source are moving relative to one another. The energy storage device is further configured to power at least one of the vehicle and the appliance using the electrical energy stored in the energy storage device.

One or more of the following features may be included. The energy storage device may include at least one of one or more capacitors, one or more chemical energy storage devices, one or more inductive energy storage devices, one or more electro-mechanical energy storage devices, one or more electro-pneumatic storage devices, one or more electro-hydraulic storage devices, and one or more batteries. One or more switches may be operatively connected to the energy storage device. The one or more switches may be configured to switch the one or more temporary circuits into and out of electrical contact with the source while the energy storage device and the source are moving relative to one another. The one or more temporary circuits may be sequentially made and then sequentially broken while the energy storage device and the source are moving relative to one another. The timing of the sequentially made and sequentially broken one or more temporary circuits, while the energy storage device and the source are moving relative to one another, may result in at least one of an increasing and decreasing energy level over time of the energy storage device. The amount of the electrical energy received from the source may be based upon, at least in part, at least one of one or more preset parameters and one or more time-varying parameters. The one or more preset parameters and the one or more time-varying parameters may include at least one of an estimate of an initial charge state of the energy storage device, a speed of the energy storage device moving by at least one of the source and a second source, a future distance between at least one of the source and a second source, and a future time between the energy storage device moving by the source. The one or more temporary circuits created through the energy storage device and the source while the energy storage device and the source are moving relative to one another may be created in response to a contactless interaction between, at least in part, the energy storage device and the source. The one or more temporary circuits created through the energy storage device and the source while the energy storage device and the source are moving relative to one another may be created in response to a mechanical contact between, at least in part, the energy storage device and the source. A second energy storage device may be operatively connected to the energy storage device. The second energy storage device may be configured to automatically connect in at least one of series and parallel with the energy storage device when the energy storage device contains insufficient electrical energy to power a load. A switch may be configured to switch the energy storage device to match an impedance to a load in response to a slowing movement of the vehicle operatively connected to the energy storage device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of an example energy storing system according to one or more embodiments of the disclosure;

FIG. 2 is an illustrative diagrammatic view of an example energy storing system according to one or more embodiments of the disclosure;

FIG. 3A is an illustrative diagrammatic view of an example energy storing system according to one or more embodiments of the disclosure;

FIG. 3B is an illustrative diagrammatic view of an example energy storing system according to one or more embodiments of the disclosure;

FIG. 3C is an illustrative diagrammatic view of an example energy storing system according to one or more embodiments of the disclosure;

FIG. 4 is an illustrative diagrammatic view of an example power flow diagram of the energy storing system according to one or more embodiments of the disclosure;

FIG. 5 is an illustrative diagrammatic view of an example power flow diagram of the energy storing system according to one or more embodiments of the disclosure;

FIG. 6 is an illustrative diagrammatic view of an example power flow diagram of the energy storing system according to one or more embodiments of the disclosure;

FIG. 7 is an illustrative diagrammatic view of an example energy storing system according to one or more embodiments of the disclosure;

FIG. 8 is an illustrative diagrammatic view of an example energy storing system according to one or more embodiments of the disclosure; and

FIG. 9 is an illustrative diagrammatic view of an example energy storing system according to one or more embodiments of the disclosure.

Like reference symbols in the various drawings indicate like elements.

### DETAILED DESCRIPTION OF THE EMBODIMENTS

### System Overview

While one or more embodiments of the disclosure may relate to such things as, for example, electrically powered passenger trains, trolleys, buses, and similarly configured freight conveyances, those skilled in the art will appreciate that the disclosure may be applied to any vehicle (e.g., cars, motorcycles, earth movers, aircraft, etc.) and/or any electronic device (e.g., personal computers, sensors, communications devices, robots, laptop computers, smart phones, notebook computers, tablets, power tools, etc.) or any other type of device that may receive power from an energy storage device. As such, the use of a train should be taken as an example only, and not to otherwise limit the scope of the disclosure.

Some of the above mentioned vehicles may obtain motion or operating electric power from, e.g., electrical conductors (galvanic contact) or from storage batteries. With regard to trains, one or more propulsion cars or locomotives may receive electric current substantially continuously by galvanic contact to, e.g., a distributed electric transmission system placed contiguous to the route of the train. For example, a train system configuration may have, for example, a single, fixed overhead bare wire, a catenary, energized with a certain voltage of alternating current (AC), though direct current (DC) systems are known. Each powered car or cars (e.g., locomotive) of the train may have a pantograph device to reach up and hold an electrical conductor in sliding contact with the overhead wire as the train moves and may conduct electrical current down into the locomotive. To complete the electrical circuit, the metal tracks upon which the train moves may serve as the return electrical path. In operation, electrical controls within the locomotive may draw variable amounts of current from the catenary, e.g., as needed for propulsion, and may convert the current to a suitable voltage and one or more phases or waveforms for driving, e.g., traction motors connected to friction wheels on trucks or bogies in contact with the tracks.

Numerous disadvantages may exist, e.g., within an electric train system as described. For example, the train may only travel where an overhead power wire has been previously installed. Such overhead wires and their associated electrical transmission networks, with periodic substations for power conversion and regulation along the path of the train, may be complex and expensive. As another example, the cost per kilometer of the poles and/or towers, cantilevers to suspend the wire and the wire itself may be substantial. Such infrastructure may be subject to weathering, storm damage, and vandalism, which may result in frequently required inspection and maintenance. As another example, using the train track as a counter-electrode to the overhead power wire may place stringent demands upon the continuity of the track and integrity of the associated electrical contacts, as well as potentially requiring that the locomotive wheels be made of conductive material and bearings and/or potentially requiring that other contact means to the wheels are electrically conductive, all of which also may be subject to damage and require constant maintenance.

The nature of the electric power carried on the overhead catenary wire also may be problematic. For example, because the transmission distances may be commensurate with train travel, e.g., tens or hundreds of kilometers, high voltages of approximately 25-30 kilovolts (kV) may be placed upon the catenary, such that the correspondingly lower currents may encounter less electrical losses from, e.g., Joule heating resistive loss. The electrical control and drive systems within the locomotive may require voltages on the order of 1000 to 2000 volts, however, such that the locomotive may contain a transformer to step down the received voltage to a usable voltage. The overhead AC power may be at the same frequency, e.g., 50-60 Hz, and may be used for terrestrial power transmission, and the power levels per locomotive may be on the order of, e.g., one to several megawatts continuous duty for high speed cruise (e.g., French TGV Atlantique 24000 series and Japanese shinkansen power cars), such that the transformer in the locomotives may be quite massive, and may thus incur a cost to accelerate and decelerate and may hence detract from energy efficiency of operation. For example, each TGV train may have two power cars, each with a transformer weighing 8,000 kg=17,600 pounds=8.8 tons, not counting a forced oil cooling systems with forced air radiators to cool the oil.

Another possible issue may be that even the stepped-down single-phase AC power may not be used directly, but may be rectified to DC and used by inverters to synthesize three variable-frequency AC phases per traction motor, often for two or more motors. Moreover, these rectification and conversions may be done using solid-state or semiconductor components, such as silicon-controlled rectifiers, thyristors, IGBTs, etc., which may require that they be maintained at low temperatures (<250° C.=480° F.), thus are heavily cooled and produce distributed, low-grade waste heat.

As will be discussed in greater detail below, in some example embodiments, the disclosure generally relates to a vehicle (e.g., locomotive) with storage of electrical energy by one or more capacitors. For example, the capacitors may be charged up to a DC potential while the train and locomotive is passing (i.e., in motion) through a charging station. While stationary and/or in motion, the locomotive may draw from the stored electrical energy in, e.g., its on-board capacitors to propel the train for some distance and time until the locomotive may again charge its capacitors (e.g., while in motion) at the same or a different charging station. The train may travel, e.g., without a need for electrical transmission systems and catenaries having been previously installed. The train track, the train wheels, the wheel bearings and so forth need not be conductors, so, for example, the track and/or wheels may be made of polymers, composites, ceramics, lightweight metals, plastic or rubber, for smoothness of ride or quietness of rolling. Since the locomotive's capacitors may store energy via positive-negative charge separation, drawing energy out of the capacitors may result in DC power, potentially eliminating a need for rectifiers. Additionally, unlike current vehicles that may use capacitors and may be required to stop for minutes at a time to receive a charge, in some embodiments the disclosure may enable trains to receive a charge rapidly and while in motion (i.e., without having to stop) and even at operational speeds. As will also be discussed in greater detail below, in some embodiments a switched capacitor network may enable adjustment of the voltage supplied to the locomotive's wheel-drive control electronics, e.g., without requiring heavy transformers.

As discussed above and referring also to FIGS. 1-9, an apparatus may comprise an energy storage device. The Energy storage device may include, for example, one or more capacitors 130 (e.g., one of one or more electrostatic capacitors, one or more super capacitors, one or more ultra capacitors, etc., or combination thereof). However, those skilled in the art will recognize that other types of energy storage devices, such as one or more chemical energy storage devices, one or more inductive energy storage devices, one or more electro-mechanical energy storage devices, one or more electro-pneumatic storage devices, one or more electro-hydraulic storage devices, one or more batteries, etc., or combination thereof, may also be used. As such, while the following description is described in terms of using a capacitor(s) 130 as energy storage device, the use of a capacitor should be taken as an example only and not to otherwise limit the scope of the disclosure.

The energy storage device (e.g., capacitor 130) may be configured to store electrical energy received from a source (e.g., charging station 20). Capacitor 130 may be configured to store the electrical energy received from charging station 20 via one or more temporary circuits created through capacitor 130 and charging station 20 while capacitor 130 is moving by charging station 20.

For example, a vehicle (e.g., locomotive 10) may propel a train (e.g., train 12) along a route (e.g., route 40) within and/or between one or more cities (e.g., cities 60). At appropriate intervals of distance, one or more charging stations 20 may be located near route 40 of train 12. As locomotive 10 passes by or through charging station 20, electric charge separation may be engendered in one or more capacitors 130 on board locomotive 10 by an interaction of locomotive 10 with charging station 20 while train 12 continues moving (e.g., at normal speed). Thus, whether locomotive 10 is static and/or in motion, energy may be imparted to and stored within locomotive 10 in the form of, e.g., electric fields associated with positive-from-negative charge separation facilitated by capacitor 130 of the locomotive. This stored energy may then be used over time to propel locomotive 10 and train 12 between charging stations 20. In addition to receiving energy from capacitor charging station 20, the locomotive may also recharge its capacitors using electrical energy generated on board the locomotive or train from recovery of otherwise waste heat, from regenerative braking or from an auxiliary generator, among other possible sources.

As noted above, the energy transfer received from charging station 20 by capacitor 130 while capacitor 130 is moving by charging station 20 may be accomplished via at least one (e.g., temporarily existing) circuit (e.g., bipolar direct-current (DC) circuit) completed through charging station 20 and the moving locomotive 10. Charging station 20 may set up a desired voltage or electric potential across, e.g., respective positive and negative poles of charging station 20 and drive an electric current flow from the positive pole to the negative pole through locomotive 10 while locomotive 10 is transiently in, e.g., galvanic and/or mechanical contact with charging station 20 and completing the circuit. The current flow driven by charging station 20 may be accommodated by capacitor 130 within locomotive 10 developing a charge separation on the terminals and internal plates or electrodes of capacitor 130.

Charging station 20 may provide a time-varying DC potential between its positive and negative poles, with concomitant time-varying current flowing between them, during the time period in which locomotive 10 may be in electrical contact with charging station 20. Likewise, locomotive 10 may be configured to respond to or react to the voltages and currents presented by charging station 20, or to other stimuli or controls, with time-varying internal impedances, capacitance values, or other adjustable electrical parameters. That is, the amount of the electrical energy received by capacitor 130 from charging station 20 may be based upon, at least in part, at least one of one or more preset parameters and one or more time-varying parameters. The one or more preset parameters and the one or more time-varying parameters may include at least one of an estimate of an initial charge state of capacitor 130, a speed of capacitor 130 (e.g., within locomotive 10) moving by at least one of charging station 20 and a next source (e.g., charging station), a future distance between at least one of charging station 20 and a next source (e.g., charging station), and a future time between when capacitor 130 may move by at least one of charging station 20 a next source (e.g., charging station), other operational parameters of locomotive 10 or the train system, and combination thereof.

According to one or more embodiments, communication means, such as radios, may be used to obtain estimates of some of the above noted parameters prior to locomotive 10 entering charging station 20. According to one or more embodiments, devices such as computers and micro-controllers may be used within locomotive 10, within charging station 20 or elsewhere to calculate and control desirable values of the aforementioned preset and time-varying parameters.

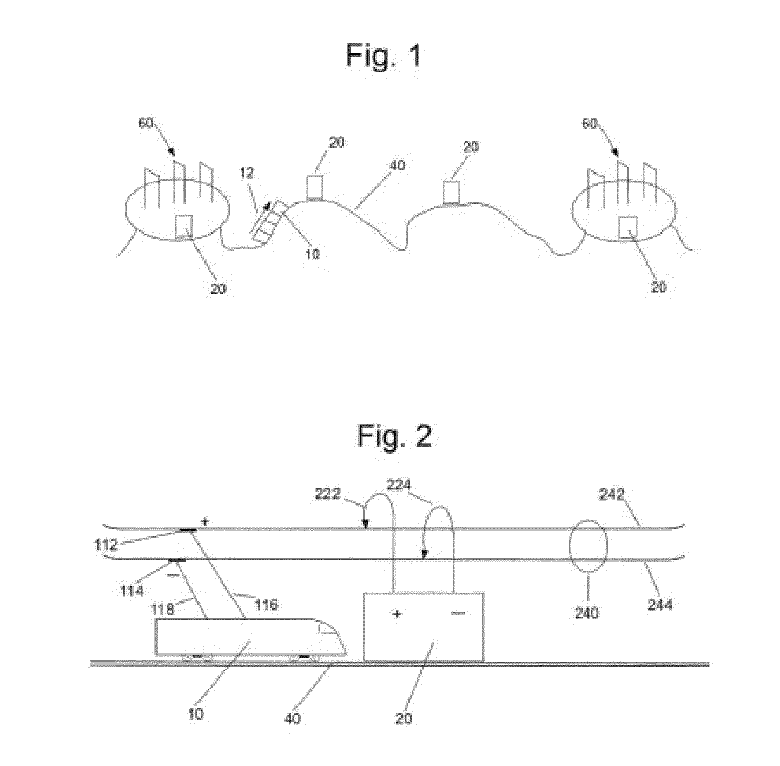

According to one or more embodiments, energy may be imparted to locomotive 10 by charging station 20. For example, as locomotive 10 moves along a path (e.g., path 40) toward charging station 20, one or more temporary circuits may be created in response to locomotive 10 coming into mechanical (i.e., tangible) contact/interaction and/or electrical (i.e., contactless, following the mechanical contact but not requiring the mechanical contact, etc.) interaction with charging runner 240 associated with charging station 20. Charging runner 240 may be elongated in the moving direction of path 40 of locomotive 10 and may be disposed generally parallel to the moving direction, though other modifications may be possible. For instance, the curved ends shown in FIG. 2 may, according to one or more embodiments, facilitate initial mechanical engagement with the moving locomotive. Charging runner 240 may be, for example, held, fastened or suspended, rigidly or flexibly, in proper position and orientation for interaction with locomotive 10.

While charging runner 240 is shown as two separate mechanical structures, e.g., in view of the bipolar property of the charging circuit, with a positive conductor runner 242 and a negative conductor runner 244, those skilled in the art will appreciate that the electrically distinct runner members 242 and 244 may be, for example, two different sides, electrically isolated from each other, of a single runner 240. As one example, to distribute large electrical currents, runner members 242 and 244, according to one or more embodiments, may be constructed each as a plurality of sub-members 242a, 242b, 242c, etc. and 244a, 244b, 244c, etc., each substantially parallel to 240. The sub-members may be, e.g., electrically common or electrically isolated from one another. Charging runner 240 with its electrically distinct members, 242 and 244, may be energized by at least electrical connections 222 and 224 from charging station 20. As shown, items 222 and 242 may be electrically positive with respect to 224 and 244, while items 224 and 244 may be electrically negative with respect to 222 and 242, though either set of items may be connected to ground or earth potential without affecting operation.

Charging runner 240's electrically distinct members 242 and 244, and any sub-members, may be electrically conductive along their elongated dimension or length. However, according to one or more embodiments, 242 and 244 may be sub-divided into segments along the length of 240 with electrical isolation between segments. Therefore, in addition to the single electrical connections 222 and 224 from charging station 20, there may be a plurality of electrical connections 222 and a plurality of electrical connections 224 to separately energize parallel sub-member runners and/or length-wise runner segments.

According to one or more embodiments, and as noted above, locomotive 10 may interact with charging station 20 using appropriate means to make mechanical and/or electrical contact with charging runner 240. For example, in an example of mechanical interaction (and thus following thereafter electrical interaction), conductive electrodes 112 and 114 may slide, rub, roll, brush, or otherwise mechanically touch along electrically distinct runner members 242 and 244, respectively, of 240 as locomotive 10 (e.g., with capacitor 130) is moving. Pantographs 116 and 118, or mechanical fixturing with equivalent function, may position and apply mechanical contact force to electrodes 112 and 114, respectively, as well as conduct electrical current to and from locomotive 10 to complete the charging circuit. Corresponding to the separate parallel sub-member runners and/or length-wise runner segments described for charging runner 240 above, electrodes 112 and 114 may include a plurality of individual electrical contacts, either electrically common and/or electrically isolated from one another. Accordingly, pantographs 116 and 118 may have the required number of separate conductors. Thus, a plurality of temporarily existing bipolar direct-current (DC) circuits may be completed through the charging station and the moving locomotive 10 (e.g., via capacitor 130) to transfer energy to locomotive 10.

According to one or more embodiments, each of the plurality of such charging circuits are not required to be energized at any one time, although this may aid in rapid charging. For example, rapid charging may be beneficial since, without limitation, locomotive 10 may be moving at, e.g., 300 km/hour=83.3 meters/second, thus, if charging runner 240 is 100 meters long, the time duration of electrical contact between locomotive 10 and charging station 20 may only be approximately 1.2 seconds.

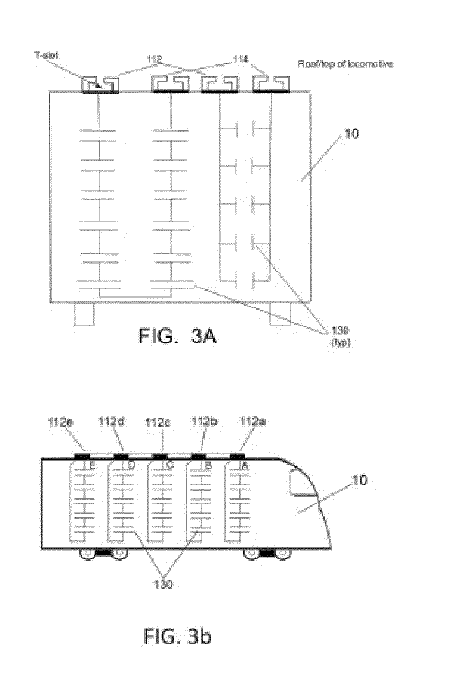

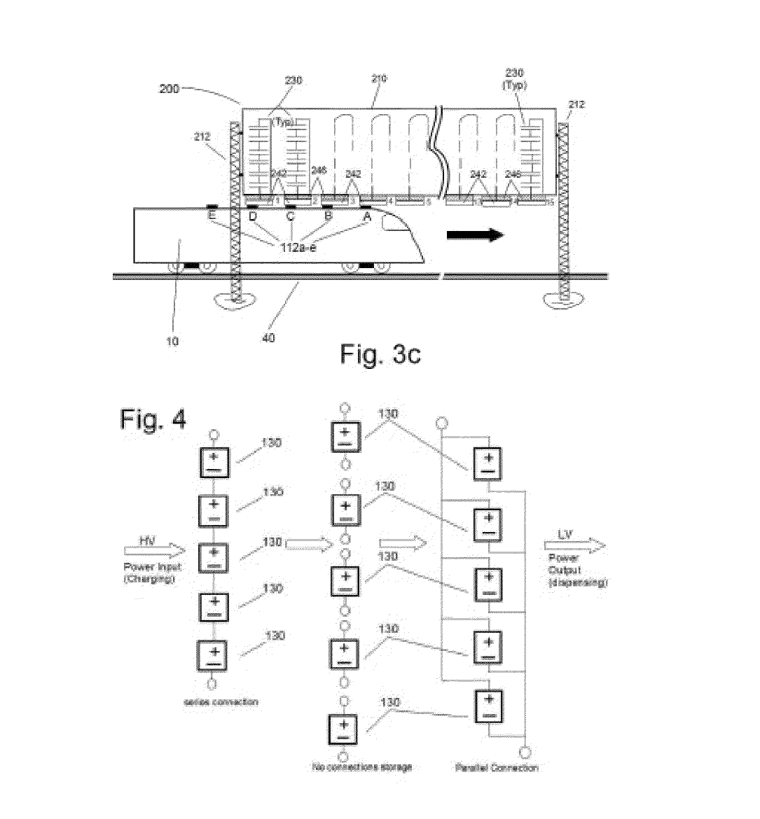

According to one or more embodiments, and referring at least to FIGS. 3A-C, an alternative interaction between energy storage device of locomotive 10 and charging station 20 is illustrated. For example, FIG. 3A shows a cross-section of locomotive 10 with specific locations of one or more capacitors 130 (e.g., capacitor banks). According to one or more embodiments, two groups or banks of one or more capacitors 130 are shown, one in series and the other in parallel connection topologies, though mixed serial and parallel topologies within one or more banks also may be used throughout. Each bank of capacitors 130 may illustratively have a pair of charging electrodes depicted on or near the roof of locomotive 10 (although other locations are possible) with 112 being positive charging electrodes and 114 being negative charging electrodes. The charging electrodes shown may be T-slot channels extending into and out of the figure, along the length and direction of motion of locomotive 10, which are configured to receive T-shaped-cross-section charging runners 242 and 244 of charging station 20. Those skilled in the art will appreciate that other patterns of charging electrodes and runners may be used without departing from the scope of the present disclosure. According to one or more embodiments, there may be more than two pairs of charging electrodes, including more than one pair of charging electrodes per capacitor bank.

Referring at least to FIG. 3B, a side cut-away of locomotive 10 is shown and indicates a plurality of capacitor banks 130 A, B, C, D and E along the length of locomotive 10, each with its own at least one pair of charging electrodes, only the positive ones of which are visible, 112a, 112b, 112c, 112d and 112e, respectively. Each of the plurality of charging electrodes may be electrically isolated from any other charging electrodes, although designs with some electrical commonality among charging electrodes may also be used without departing from the scope of the disclosure. According to one or more embodiments, pantographs 116 and 118 may not be required, and mechanical fixturing, interior to the locomotive, of the charging electrodes may facilitate engagement with the charging runners of charging station 20.

According to one or more embodiments, and referring at least to FIG. 3C, a partially cut-away side view is shown of the locomotive 10 of at least FIGS. 3A and 3B moving into charging station 20. According to one or more embodiments, charging station 20, may include an energy storage device house (e.g., capacitor house 210) positioned above the path 40 of train 12 by, e.g., one or more supports 212. Capacitor house 210 may fulfill at least an energy storage function and an energy dispensing function of charging station 20. For example, in capacitor house 210, a plurality of capacitor banks 230 may be disposed along the length of capacitor house 210 parallel to path 40 of locomotive 10. According to one or more embodiments, each capacitor bank 230 (which may be an energy storage bank of any type of energy storage device) may be electrically connected to one or more segments of positive charging runners 242 and negative charging runners 244, where only the positive ones are illustratively shown. Electrical insulators 246 may isolate the segments of the charging runners from the outer surfaces of capacitor house 210. Each of the plurality of charging runner segments is shown electrically isolated from any other ones, although designs with some electrical commonality among charging segments may exist without departing from the scope of the disclosure.

The embodiment(s) depicted in FIGS. 3A, 3B and 3C may minimize the length of conductors between capacitors and charging electrodes and/or charging runners. Short length of conductors may minimize series resistance and series inductance of conductors as well as reduce mutual capacitance and induced currents between conductors, all of which may aid rapid flow of current from capacitors 230 to capacitors 130.

According to one or more embodiments, a charging facility, either part of charging house 210 or a separate structure, may at least help to fulfill at least an energy input function and a combined control and communications function for charging station 20. The charging facility may be configured to receive any available form of energy and convert the energy for electric storage in the capacitor banks 230 in an energy storage section of capacitor house 210. According to one or more embodiments, such energy intake, conversion, and storage in capacitor banks 230, i.e., charging, may require, for example, AC transformers, AC-to-DC rectifiers, switches and/or routers for electrical current, electrical conductors and buses, various sensors and measurement devices and/or systems, as well as other apparatus for safety, cooling, data logging and other desirable functions, or combination thereof. Operable control of, in particular, the switches used to configure capacitor banks 230 for charging, as well as to configure capacitor banks 230 for dispensing stored energy to locomotive 10 (e.g., via capacitor 130), may be a shared function of the charging facility and capacitor house 210.

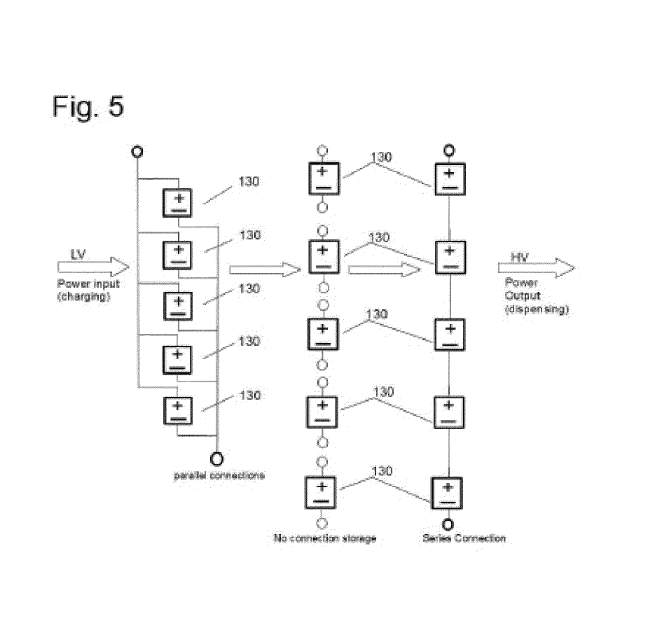

According to one or more embodiments, such a collection of controlled switches and capacitors may be known as a switched-capacitor fabric, a switched-capacitor network or a switched-capacitor array. Example implementations of operating the switched-capacitor fabric within capacitor house 210 are shown in FIGS. 4 and 5 with reference to a switched-capacitor fabric within locomotive 10. However, those skilled in the art will appreciate that the implementations may operate in substantially time-reversed sequence for capacitor house 210 compared with locomotive 10, as the former may involve a charging of capacitors while the latter may involve a discharging of capacitors.

According to one or more embodiments, one or more switches may be operatively connected to capacitor 130 and/or charging station 20. The one or more switches may be configured to switch the one or more temporary circuits into and out of electrical contact with the source while capacitor 130 is moving by charging station 20. For example, as locomotive 10 moves through charging station 20, each of the capacitor banks 130 A-E in locomotive 10 may be switched, in turn, into and out of electrical contact with capacitor banks 230 1, 2, 3, . . . n in capacitor house 210. Those skilled in the art will recognize that any number of capacitor bank(s) may be used without departing from the scope of the disclosure.

According to one or more embodiments, the switching action may be initiated, driven, and timed based upon, at least in part, the motion and/or momentum of locomotive 10 relative to capacitor house 210. While one or more embodiments may be described as locomotive 10 moving and charging station 20 terrestrially fixed, those skilled in the art will appreciate that locomotive 10 may be stationary and charging station 20 may be moving (e.g., on another train running on a parallel track or path). As such, any description of capacitor 130 of locomotive 10 “moving” should be interpreted as capacitor of locomotive 10 moving relative to charging station 20, which may also include charging station 20 being the moving object. In either case, switch closure (conduction) may include mechanical touching and/or electrical interaction of any of locomotive 10's charging electrodes 112a, 112b, 112c, 112d and 112e and their negative counter-electrodes to any of capacitor house 210's charging runner segments 242 numbered 1, 2, 3, . . . n, and their negative counterparts, the segment numbers corresponding to capacitor bank(s) 1, 2, 3, . . . n.

For instance, according to one or more embodiments, assume for example purposes only that it is planned that a locomotive traveling at 300 km/hr may spend as little as 1 second in the charging station, so the mode of use of the embodiment of FIG. 3C is that the capacitor banks 230 should be charged to their desired initial voltages, and no further charging or recharging need occur during interaction with the passing locomotive. In this example, all the capacitor banks of capacitors 130 in locomotive 10 may be charged-up to approximately 30 kilovolts (kV) after the locomotive departs charging station 20. It is contemplated that there may be some shortcomings of present-day switch-gear, e.g., with charging runners 242 and 244 and charging electrodes 112 and 114, and other conductors, there may be material failure or melting while carrying extremely large electric currents.

As such, according to one or more embodiments, large banks of capacitors 230 may not be discharged into similarly large banks of capacitors 130 at high voltage differentials. According to one or more embodiments, capacitor banks 1, 2, 3, . . . n of charging station 20 may be pre-charged with increasingly higher voltages going from charging runner segment 1 to n. For instance, assume for example purposes only that the pre-charge values start at, e.g., 5 kV for charging runner segment 1 and increase in, e.g., 5 kV steps until, e.g., 30 kV is reached (e.g., 10 kV for charging runner segment 2, 15 kV for charging runner segment 3, etc. up to 30 kV for charging runner segment 6), then remain at 30 kV for the rest of the runner segments out to n. For ease of explanation only, let the capacitance values of the capacitor banks A-E in locomotive 10 and the capacitor banks 1, 2, 3, . . . n in capacitor house 210 all be equal to each other. Also, assume zero resistance and inductance in the charging circuits, so charge transfer between the charging capacitor bank and the to-be-charged capacitor bank is essentially instantaneous. Since in the example the capacitances are equal, the charge may be shared equally and both capacitor banks may end up at the same voltage, the voltage half way in between their two initial voltages.

According to one or more embodiments, the one or more temporary circuits may be made (e.g., sequentially) and then may be broken (e.g., sequentially) while capacitor 130 (e.g., capacitor bank) of locomotive 10 is moving by charging station 20. The timing of the sequentially made and sequentially broken one or more temporary circuits, while capacitor banks 130 of locomotive 10 are moving by charging station 20, may result in at least one of an increasing and decreasing energy level over time of capacitor banks 130. For instance, assume further for example purposes only that the locomotive's capacitor banks are completely discharged before entering charging station 20. Then, in operation, locomotive's bank A may first hit runner segment 1, equilibrate charge and voltage with it, then hit segment 2, equilibrate with it, then hit segment 3, equilibrate with it and so forth.

Meanwhile, after bank A goes by, locomotive's bank B hits segment 1, which as been depleted by bank A, equilibrates with the depleted segment 1, then hits segment 2, which has been depleted by bank A, equilibrates with it and so forth. Later locomotive's bank C hits segment 1, which as been depleted by banks A and B, equilibrates with the depleted segment 1, then hits segment 2, which has been depleted by banks A and B, equilibrates with it and so forth. This compound sequence continues for banks D and E of the locomotive and runner segments 4 through n (e.g., 15) of charging station 20. TABLE 1 gives the resulting voltages on locomotive's banks A-E and on charging station's banks 1-15 after each of the locomotive's banks pass by.

TABLE 1
TABLE 1. Voltage on both station and locomotive capacitor banks

| | | Runnor segment number | | | | | | | | | | | | | | |
|---|---|---|---|---|---|---|---|---|---|---|---|---|---|---|---|---|
| (all voltages in kV) | | 1 | 2 | 3 | 4 | 5 | 6 | 7 | 8 | 9 | 10 | 11 | 12 | 13 | 14 | 15 |
| Voltage on segment | | 5 | 10 | 15 | 20 | 25 | 30 | 30 | 30 | 30 | 30 | 30 | 30 | 30 | 30 | 30 |
| before A | | | | | | | | | | | | | | | | |
| Voltage on bank A | 0 | 2.50 | 6.25 | 10.63 | 15.31 | 20.16 | 25.08 | 27.54 | 28.77 | 29.38 | 29.69 | 29.85 | 29.92 | 29.96 | 29.98 | 29.99 |
| Voltage on segment | | 2.50 | 6.25 | 10.63 | 15.31 | 20.16 | 25.08 | 27.54 | 28.77 | 29.38 | 29.69 | 29.85 | 29.92 | 29.96 | 29.98 | 29.99 |
| after A | | | | | | | | | | | | | | | | |
| Voltage on bank B | 0 | 1.25 | 3.75 | 7.19 | 11.25 | 15.70 | 20.39 | 23.96 | 26.37 | 27.88 | 28.78 | 29.32 | 29.62 | 29.79 | 29.89 | 29.94 |
| Voltage on segment | | 1.25 | 3.75 | 7.19 | 11.25 | 15.70 | 20.39 | 23.96 | 26.37 | 27.88 | 28.78 | 29.32 | 29.62 | 29.79 | 29.89 | 29.94 |
| after B | | | | | | | | | | | | | | | | |
| Voltage on bank C | 0 | 0.63 | 2.19 | 4.69 | 7.97 | 11.84 | 16.11 | 20.04 | 23.20 | 25.54 | 27.16 | 28.24 | 28.93 | 29.36 | 29.62 | 29.78 |
| Voltage on segment | | 0.63 | 2.19 | 4.69 | 7.97 | 11.84 | 16.11 | 20.04 | 23.20 | 25.54 | 27.16 | 28.24 | 28.93 | 29.36 | 29.62 | 29.78 |
| after C | | | | | | | | | | | | | | | | |
| Voltage on bank D | 0 | 0.31 | 1.25 | 2.97 | 5.47 | 8.65 | 12.38 | 18.21 | 19.71 | 22.62 | 24.89 | 26.57 | 27.75 | 28.55 | 29.09 | 29.43 |
| Voltage on segment | | 0.31 | 1.25 | 2.97 | 5.47 | 8.65 | 12.38 | 18.21 | 19.71 | 22.62 | 24.89 | 26.57 | 27.75 | 28.55 | 29.09 | 29.43 |
| after D | | | | | | | | | | | | | | | | |
| Voltage on bank E | 0 | 0.16 | 0.70 | 1.84 | 3.65 | 6.15 | 9.27 | 12.74 | 16.22 | 19.42 | 22.16 | 24.36 | 26.05 | 27.30 | 28.20 | 28.82 |
| Voltage on segment | | 0.16 | 0.70 | 1.84 | 3.65 | 6.15 | 9.27 | 12.74 | 16.22 | 19.42 | 22.16 | 24.36 | 26.05 | 27.30 | 28.20 | 28.82 |
| after E | | | | | | | | | | | | | | | | |

In this example, time-varying charging parameters may be achieved in a mechanical and/or electrical “ripple effect” over a portion of the distance of charging station 20. As can be seen in the example, the voltages on locomotive's banks A-E and on charging station's banks 1-15 may be exactly equal after each two-capacitor interaction. This may be a result of the assumptions of zero resistance and inductance in the charging circuits. Those skilled in the art will appreciate that realistic values may be included in the calculation and may delay charging of the locomotive's capacitor banks to a given voltage out to higher segment number of the charging station. Varying values of capacitances, pre-charge voltages, numbers of station runner segments, etc., may be calculated and used without departing from the scope of the disclosure.

According to one or more embodiments, within locomotive 10 and referring at least to FIGS. 4 and 5, electric current flowing in the one or more temporarily existing charging circuits may be a power flow from stored energy in capacitors 230 of charging station 20 to capacitors 130 of locomotive 10, which may result in stored energy in capacitors 130. FIG. 4 shows an example in which a higher potential than needed to operate locomotive 10 is available from charging station 20. In this example, a number of capacitors may be electrically connected in series for charging, i.e., positive-terminal-to-negative-terminal for adjacent capacitors, to receive a power flow resulting in electrical charge separation in the capacitors. FIG. 4 is a logical power flow diagram indicating that a number of capacitors 130 may be connected in series to receive power, may then be disconnected to store energy and may be later connected in parallel for dispensing of a charge in the form of electrical current which may be used as power for operating locomotive 10.

According to one or more embodiments, and referring at least to FIG. 5, an example is shown in which a lower potential than needed to operate locomotive 10 is available from charging station 20. In this example, a number of capacitors may be electrically connected in parallel, i.e., all positive terminals connected together and all negative terminals connected together, to receive a power flow resulting in electrical charge separation in the capacitors. FIG. 5 is an example logical power flow diagram indicating that a number of capacitors 130 may be connected in parallel to receive power, may then be disconnected to store energy and may be later connected in series for dispensing of a charge in the form of electrical current which may be power for use of locomotive 10.

According to one or more embodiments, there may be provided voltage-level-shifting of DC signals and power flows energy-efficiently with “simple”, low-mass components. For example, FIG. 4 shows an example where it may be provided voltage step-down in the DC domain without any transformers, and FIG. 5 shows an example where it may be provided voltage step-up in the DC domain without any transformers. Those skilled in the art will recognize that various combinations of series and parallel connections of capacitors may be used during charging, storage, and dispensing phases of operation.

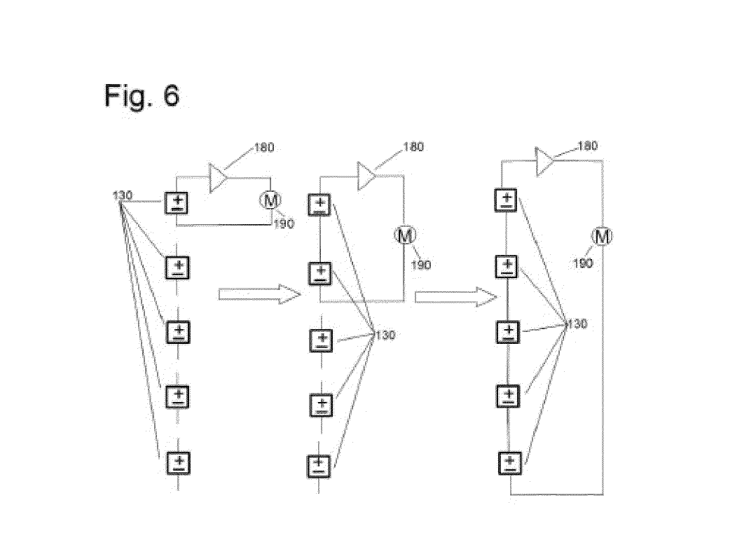

According to one or more embodiments, a second energy storage device (e.g., capacitor) may be operatively connected to capacitor 130 and may be configured to automatically connect in at least one of series and parallel with capacitor 130 when, for example, capacitor 130 contains insufficient electrical energy to power a load (e.g., electrical load 190). For instance, according to one or more embodiments, and referring at least to FIG. 6, an example of the logical power flow over a period of time is shown by which already-charged individual capacitors 130 are successively connected in series and discharged through electrical load 190, e.g., as controlled by a regulator 180. In the case of locomotive 10, load 190 may be a traction motor connected to driving wheels and regulator 180 may be a variable-speed electronic motor drive unit.

FIG. 6 also shows an example logical progression in which on the left it is shown that the voltage of one charged-up capacitor 130 is sufficient to power regulator 180 plus load 190 for a period of time. After some period of time, charge drawn out of capacitor 130 may reduce the voltage across capacitor 130 to a level insufficient to power regulator 180 plus load 190. Accordingly, as shown in the middle circuit of FIG. 6, a second, fully-charged capacitor 130 may be brought into series connection with the original, now partially-discharged, capacitor 130. This action may raise the voltage across the two series-connected capacitors 130 to a level sufficient to power regulator 180 plus load 190 for a period of time.

As indicated on the right side of FIG. 6, the process of sequentially adding fully-charged capacitors 130 into the series capacitor chain powering regulator 180 plus load 190 may be extended to a plurality of capacitors. According to one or more embodiments, the voltage across regulator 180 plus load 190 may be maintained substantially constant, within a range equal to the value of the charged-up voltage of one or more of capacitor 130.

According to one or more embodiments, there exists the opportunity for nearly complete exhaustion of the stored charge in capacitors 130, which may result in a high utilization factor of the initial stored energy in capacitors 130. For example, if the voltage across regulator 180 plus load 190 is maintained substantially constant while a number n of capacitors 130 have been added into the series chain, the voltage across any one capacitor 130 may be 1/n of the voltage across regulator 180 plus load 190. The remaining charge in any of the n capacitors may be Q=CV, where Q is charge in coulombs, C is capacitance in farads and V is the voltage across any one capacitor. Thus Q_{final} will be 1/n of the fully charged Qᵢₙᵢₜᵢₐₗ, so the larger the number n, the more fully utilized the initial stored energy may be in any capacitor 130. In addition, the energy either stored or released by a capacitor may be the potential difference (voltage) across the capacitor times the quantity of charge either stored or released, so energy utilization may be dependent upon this arithmetic QV product, not simply upon Q or V. This may be contrasted with one or more alternate embodiments of simply replacing a partially discharged capacitor 130 in the left circuit of FIG. 6 with a fully charged-up capacitor. In that alternate embodiment, the voltage of the removed capacitor, while insufficient to power regulator 180 plus load 190, may still be quite large, and the remaining stored charge may be correspondingly large (by Q=CV), so the remaining, unused stored energy may be also quite large.

While one or more embodiments may be described in the context of providing power to a finely controllable load 190 utilizing regulator 180, those skilled in the art will appreciate that regulator 180 need not be used to, e.g., charge other capacitors, charge batteries, power resistive heaters, power lighting fixtures, perform electric welding, etc. Those skilled in the art will also appreciate that series regulator 180 may be replaced by series passive components such as resistors or inductors, and if, additionally, parallel passive components such as capacitors, resistors, Zener diodes, etc., were placed across the load.

According to one or more embodiments, the load may be transferred to another, separate group or bank of charged-up capacitors 130 and the process of FIG. 6 may be repeated. According to one or more embodiments, single ones of mostly-discharged capacitors 130 may be removed from the series chain to make room for fully-charged capacitors to be inserted into the chain.

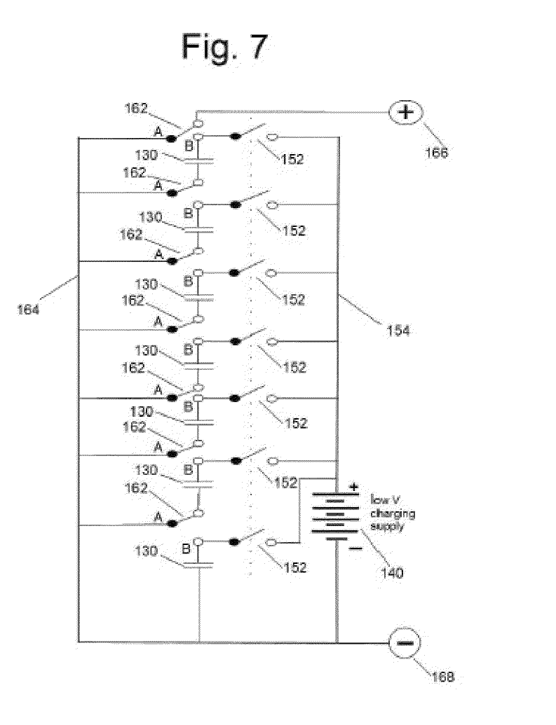

According to one or more embodiments, and referring at least to FIG. 7, the connections of individual capacitors 130 for charging and dispensing currents are symbolically represented by switches. These switches may be, for example, mechanical switches, relays, semiconductor devices (transistors, thyristors, optically-activated junctions, etc.), vacuum tubes, ganged contactors, etc. Similarly, the conductors indicated may be wires, circuit board traces, bus bars, parts of a structural frame and so forth.

According to one or more embodiments, the individual capacitors 130, e.g., in FIG. 7, may be charged-up all at one time in either series and/or parallel mode, as shown by example on the left sides of FIG. 4 and FIG. 5, respectively. For series charging, all switches 162 may be placed in position “B” and all switches 152 are open (non-conductive), then the charging voltage may be applied across terminals 166 and 168 by an external source.

For parallel charging, all switches 162 may be placed in position “A” and all switches 152 may be closed (conductive), then the charging voltage may be applied across bus bars 154 and 164 by power supply 140. After charging, capacitors 130 may be electrically isolated for energy storage mode by placing all switches 162 in position “A” and opening all switches 152. The energy dispensing mode of the example embodiment topology shown in FIG. 7 follows the concept of FIG. 6. For example, when the top switch 162 changes state from “A” to “B”, the voltage present across the top capacitor 130 may appear across output terminals 166 and 168 and may be available to drive a load. Leaving the top switch 162 in state “B”, when the second-from-top switch 162 changes state from “A” to “B”, the voltage may present across the top two capacitors 130 connected in series appears across output terminals 166 and 168 and may be available to drive a load. Leaving the top two switches 162 in state “B”, when the third-from-top switch 162 changes state from “A” to “B”, the voltage may present across the top three capacitors 130 connected in series appears across output terminals 166 and 168 and may be available to drive a load. This sequence and pattern may then be repeated for successively lower switches 162, e.g., to add more capacitors 130 into the series chain, as indicated on the right side of FIG. 6.

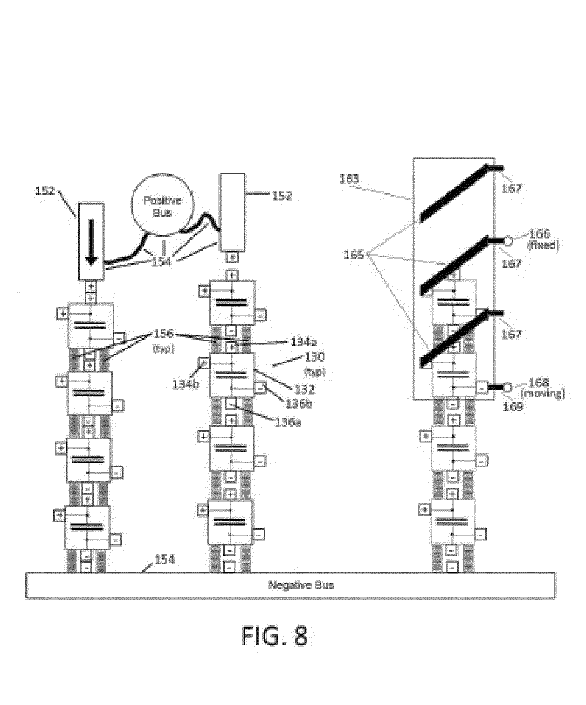

According to one or more embodiments, the topology of example FIG. 7 may be realized in the example mechanical semi-schematic diagram in FIG. 8. For example, the same group or stack of capacitors is shown in three different states: (1) charging, (2) energy storage, and (3) dispensing. In a train, automobile or human-portable appliance requiring high power (e.g., >1000 watts), one or more of such capacitor stacks may be employed. Each capacitor package 130 (depicted collectively in FIG. 8 by a single parallel-plate capacitor electrical symbol) may include a rigid or semi-rigid outer shell 132 which may contain a plurality of smaller individual capacitors in series and/or parallel. Each capacitor shell 132 may be configured with two positive terminals 134a and 134b which may be electrically equivalent, i.e., connected in parallel internally. Similarly, each capacitor shell 132 may be configured with two negative terminals 136a and 136b which may be electrically equivalent. Four capacitor packages 130 are shown in each stack, although this is for example purposes only and more or less capacitor packages may be incorporated. The depiction of the stack on the left of FIG. 8 shows the series charging mode or state. An electrically active mechanical ram 152 may press downward and compress the stack against electrically-inactive springs 156 such that all of the individual capacitor shells 132 are forced together with their proximate positive 134a and negative 136a terminals in contact to form a series chain as shown. A charging voltage from an external source may be applied across bus bars 152 and 154. Upon completion of charging, the mechanical ram 152 may move upward and the springs 156 may separate the charged-up capacitor packages 130 as shown in the central depiction of the stack in FIG. 8. This may be the energy storage state.

The depiction of the stack on the right of FIG. 8 shows an example embodiment of an energy dispensing mode implementing the concept of FIG. 6. A mechanical sliding frame switch 163 may be provided, with a plurality of diagonal electrical traces 165 to make contact between the positive and negative terminals of adjacent capacitors in the stack, thus connecting them in series. Frame 163 may be constructed of electrically insulating polymer or other suitable material. When frame 163 sides downward, in increments of distance equal to the spacing between capacitors, an additional capacitor may be added in series while all the ones above it still remain connected in series.

In the first, uppermost position of slider 163, one of traces 165 may initially make contact with terminal 134b (positive) of the top capacitor package and connect that terminal to dispensing output 166 (positive) through, e.g., brush or sliding contact 167. As indicated, positive output 166 may remain fixed while traces 165 and their respective contacts 167 index downward with frame 163. For the negative polarity, brush or sliding contact 169 may make electrical contact with 136b (negative) terminal of capacitor package 132 and conduct current to dispensing terminal 168 (negative). As shown on the right side of example FIG. 8, when sliding frame 163 has been incremented to the second position, both brush 169 and dispensing terminal 168 may move downward with frame 163. Sliding frame 163 may have a U-shaped or substantially cylindrical cross-section to reach capacitor package terminals 134b and 136b disposed on opposite sides of the stack, but it will be appreciated by those skilled in the art that terminals 134b and 136b may be disposed on the same side of the stack resulting in a simpler shape for frame 163. 134b and 136b are depicted on opposite sides for clarity of illustration only.

When it is time to add a second, third, etc. capacitor in series, frame 163 may be pushed down by a mechanical actuator, and diagonal electrical traces 165 may connect negative terminal 136b of one or more capacitors to positive terminal 134b of one or more adjacent capacitors, thus placing them in series. First trace 165 may move down with the frame as well and contact negative terminal 136b of the second-from-top capacitor and connect this to negative dispensing output 168 through, e.g., brush 169. The example downward shift of switch frame 163 may progress repetitively in steps, stages or increments of distance, as needed to connect one or more capacitors in series.

According to one or more embodiments, an alternative means of connecting the capacitor packages in series may be accomplished through partial incremental compression of the stack to force successive proximate pairs of 134a and 136a terminals sequentially into contact, similar to shown on the left side of FIG. 8 for charging. As such, any particular description of how the capacitors are connected in series (or parallel) should be taken as an example only and not to otherwise limit the scope of the disclosure. Springs 156 may not be identical in that case but may have variable spring rates or force constants. In this example, an alternate means of managing the bottom-most negative contact may be used, similar to sliding frame 163. Those skilled in the art will recognize that various combinations of at least these two schemes, and altogether different ones, may be implemented without departing from the scope of the disclosure.

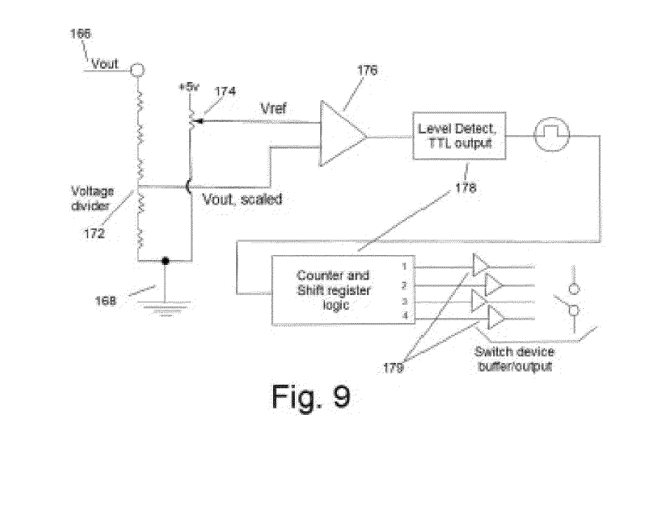

According to one or more embodiments, an example a switch controller to implement at least the sequence of FIG. 6 via apparatus of FIG. 8 or other is shown in example FIG. 9. For instance, outputs 166 and 168 from a dispensing series-connected capacitor stack may optionally provide power to a motor drive and motor, and may be sampled for voltage between them by, e.g., sensor 172. Sensor 172 is depicted as a voltage divider constructed from resistors in FIG. 9, although other types of sensors and measured parameters may be implemented. Sensor 172 may generate a voltage proportional to the voltage output to the load and this may be fed into voltage comparator 176. Comparator 176 may compare this to a reference voltage derived from reference voltage generator 174. Reference generator 174 is depicted as a potentiometer connected across a fixed-voltage power supply proximate to the comparator, which may provide a constant reference voltage, however, reference generator 174 may be, for example, associated with a speed control of locomotive 10. In such an example, the input voltage may be reduced to regulator 180 of FIG. 6 when the train is stopped, moving slowly, and/or coasting, so as to reduce heat dissipated in 180 or otherwise conserve energy.

According to one or more embodiments, when power is being dispensed from capacitors 130, their voltage may decrease over time and may eventually reach a level insufficient to power the load. At that time, the output of comparator 176 may change state. Logic 178 may be configured to detect this state change and determine which switch or switches to actuate to insert another charged-up capacitor 130 into the dispensing series-connected capacitor stack. Switch drivers 179 may convert the switching logic signals from 178 into the required control signals to actuate the appropriate switch or switches, depending upon whether the switch is actuated mechanically, electrically, optically, pneumatically, etc.

As discussed above, regenerative braking of a locomotive or other train car to generate electricity may be used to charge or recharge capacitors of locomotive 10. For example, the switched capacitor fabric or network may offer superior braking force and more complete recovery of kinetic energy of locomotive 10 into electrical energy during regenerative braking. As shown in example logical power flow diagrams FIGS. 4 and 5, capacitors 130 may be charged in series, parallel or combination thereof to suit the output voltage of the charging source. According to one or more embodiments, the effective impedance of the “load”, i.e., the capacitors, may also be varied by series or parallel topology during charging. For example, parallel capacitors may present a low impedance load and series capacitors may present a high impedance load. When applied to harvesting electrical power from regenerative braking, the voltage and the ideal matching impedance of the electrical energy produced by regenerative braking may vary constantly during braking.

According to one or more embodiments, a switch may be configured to switch the capacitors to match an impedance to a load in response to a slowing movement of the capacitors via locomotive 10. For example, generally, as locomotive 10 slows down, the voltage generated by the traction motors may decrease and the ideal network impedance to receive that energy may decrease. Using one or more of the switched capacitor stack topologies of FIG. 7, e.g., in parallel, one or more embodiments may periodically and rapidly switch more and more of the capacitors into parallel configurations to receive rectified regenerated current as locomotive 10 slows down. This regenerative braking at high torque on the traction motors may continue right down to nearly zero revolutions per minute (rpm) wheel speed, and the energy captured may stay on locomotive 10 via capacitors 130 for future use. By contrast, some currently available systems may attempt to pump current back onto the catenary, which may cease to be feasible once the generated voltage by braking drops below the catenary voltage. Once this point is reached, the regenerated power is usually “dumped” into a rheostat resistor (e.g., wasted to ambient heat). According to one or more embodiments, switching the capacitors to match the impedance to the load in response to the slowing movement of the capacitors via locomotive 10 may capture for re-use, e.g., >80% of the energy wasted by conventional rheostat braking systems.

Those skilled in the art will appreciate that each of the principles of the present disclosure may be adapted to devices with higher and/or lower power needs and/or different modes of mobility than trains. For example, a flash light or cellular phone may be simply swiped by hand through a charging station. For automobiles, a plethora of charging opportunities may exist, such as parking lots, traffic signals, toll booths and residential garages, as well as at specially designed “gates” through which a car may simply drive to be recharged.

Additionally, those skilled in the art will appreciate that, according to one or more embodiments, capacitor 130 may but need not be physically connected to locomotive 10 when receiving the charge from charging station 20. For example, in the case where capacitor 130 is used for flashlight, capacitor 130 may be removed from the flashlight and swiped by charging station 20.

The flowcharts and diagrams in the figures illustrate the architecture, functionality, and operation of possible implementations of systems adaptable to methods and computer program products according to various embodiments of the present disclosure. It will also be noted that each element in the diagrams and/or flowchart illustrations, and combinations of elements in the diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The embodiment(s) were chosen and described in order to best explain the principles of the disclosure and the practical application, and to enable others of ordinary skill in the art to understand the disclosure for various embodiment(s) with various modifications and/or any combinations of embodiment(s) as are suited to the particular use contemplated.

Having thus described the disclosure of the present application in detail and by reference to embodiment(s) thereof, it will be apparent that modifications, variations, and any combinations of embodiment(s) (including any modifications, variations, and combinations thereof) are possible without departing from the scope of the disclosure defined in the appended claims.

What is claimed is:

1. An apparatus, comprising:
an energy storage device configured to store electrical energy received from a source, wherein the energy storage device is configured to store the electrical energy received from the source via one or more temporary circuits created through the energy storage device and the source while the energy storage device and the source are moving relative to one another.

2. The apparatus of claim 1 wherein the energy storage device includes at least one of one or more capacitors, one or more chemical energy storage devices, one or more inductive energy storage devices, one or more electro-mechanical energy storage devices, one or more electro-pneumatic storage devices, one or more electro-hydraulic storage devices, and one or more batteries.

3. The apparatus of claim 1 further comprising:
one or more switches operatively connected to the energy storage device, wherein the one or more switches are configured to switch the one or more temporary circuits into and out of electrical contact with the source while the energy storage device and the source are moving relative to one another.

4. The apparatus of claim 3 wherein the one or more temporary circuits are sequentially made and then sequentially broken while the energy storage device and the source are moving relative to one another.

5. The apparatus of claim 4 wherein a timing of the sequentially made and sequentially broken one or more temporary circuits, while the energy storage device and the source are moving relative to one another, results in at least one of an increasing and decreasing energy level over time of the energy storage device.

6. The apparatus of claim 3 wherein an amount of the electrical energy received from the source is based upon, at least in part, at least one of one or more preset parameters and one or more time-varying parameters, wherein the one or more preset parameters and the one or more time-varying parameters include at least one of an estimate of an initial charge state of the energy storage device, a speed of the energy storage device moving by at least one of the source and a second source, a future distance between at least one of the source and a second source, and a future time between the energy storage device moving by at least one of the source and the second source.

7. The apparatus of claim 1 wherein the one or more temporary circuits created through the energy storage device and the source while the energy storage device and the source are moving relative to one another is created in response to a contactless interaction between, at least in part, the energy storage device and the source.

8. The apparatus of claim 1 wherein the one or more temporary circuits created through the energy storage device and the source while the energy storage device and the source are moving relative to one another is created in response to a mechanical contact between, at least in part, the energy storage device and the source.

9. The apparatus of claim 1 further comprising a second energy storage device operatively connected to the energy storage device, wherein the second energy storage device is configured to automatically connect in at least one of series and parallel with the energy storage device when the energy storage device contains insufficient electrical energy to power a load.

10. The apparatus of claim 1 further comprising a switch configured to switch the energy storage device to match an impedance to a load in response to a slowing movement of the energy storage device.

11. An apparatus, comprising:
a capacitor configured to store electrical energy received from a charging station, wherein the capacitor is configured to store the electrical energy received from the charging station via one or more temporary circuits created through the capacitor and the charging station while the capacitor and the charging station are moving relative to one another.

12. The apparatus of claim 11 wherein the capacitor includes at least one of one or more electrostatic capacitors, one or more super capacitors, and one or more ultra capacitors.

13. The apparatus of claim 11 further comprising:
one or more switches operatively connected to the capacitor, wherein the one or more switches are configured to switch the one or more temporary circuits into and out of electrical contact with the charging station while the capacitor and the charging station are moving relative to one another.

14. The apparatus of claim 13 wherein the one or more temporary circuits are sequentially made and then sequentially broken while the capacitor and the charging station are moving relative to one another.

15. The apparatus of claim 14 wherein a timing of the sequentially made and sequentially broken one or more temporary circuits, while the capacitor and the charging station are moving relative to one another, results in at least one of an increasing and decreasing energy level over time of the capacitor.

16. The apparatus of claim 13 wherein an amount of the electrical energy received from the charging station is based upon, at least in part, at least one of one or more preset parameters and one or more time-varying parameters, wherein the one or more preset parameters and the one or more time-varying parameters include at least one of an estimate of an initial charge state of the capacitor, a speed of the capacitor moving by at least one of the charging station and a second charging station, a future distance between at least one of the charging station and the second charging station, and a future time between the capacitor moving by the charging station.

17. The apparatus of claim 11 wherein the one or more temporary circuits created through the capacitor and the charging station while the capacitor and the charging station are moving relative to one another is created in response to a contactless interaction between, at least in part, the capacitor and the charging station.

18. The apparatus of claim 11 wherein the one or more temporary circuits created through the capacitor and the charging station while the capacitor and the charging station are moving relative to one another is created in response to a mechanical contact between, at least in part, the capacitor and the charging station.

19. The apparatus of claim 11 further comprising a second capacitor operatively connected to the capacitor, wherein the second capacitor is configured to automatically connect in at least one of series and parallel with the capacitor when the capacitor contains insufficient electrical energy to power a load.

20. The apparatus of claim 11 further comprising a switch configured to switch the capacitor to match an impedance to a load in response to a slowing movement of the capacitor.

21. An apparatus, comprising:
at least one of a vehicle and an appliance operatively connected to an energy storage device configured to store electrical energy received from a source, wherein the energy storage device is configured to store the electrical energy received from the source via one or more temporary circuits created through the energy storage device and the source while the energy storage device and the source are moving relative to one another, wherein the energy storage device is further configured to power at least one of the vehicle and the appliance using the electrical energy stored in the energy storage device.

22. The apparatus of claim 21 wherein the energy storage device includes at least one of one or more capacitors, one or more chemical energy storage devices, one or more inductive energy storage devices, one or more electro-mechanical energy storage devices, one or more electro-pneumatic storage devices, one or more electro-hydraulic storage devices, and one or more batteries.

23. The apparatus of claim 21 further comprising:
one or more switches operatively connected to the energy storage device, wherein the one or more switches are configured to switch the one or more temporary circuits into and out of electrical contact with the source while the energy storage device and the source are moving relative to one another.

24. The apparatus of claim 23 wherein the one or more temporary circuits are sequentially made and then sequentially broken while the energy storage device and the source are moving relative to one another.

25. The apparatus of claim 24 wherein a timing of the sequentially made and sequentially broken one or more temporary circuits, while the energy storage device and the source are moving relative to one another, results in at least one of an increasing and decreasing energy level over time of the energy storage device.

26. The apparatus of claim 23 wherein an amount of the electrical energy received from the source is based upon, at least in part, at least one of one or more preset parameters and one or more time-varying parameters, wherein the one or more preset parameters and the one or more time-varying parameters include at least one of an estimate of an initial charge state of the energy storage device, a speed of the energy storage device moving by at least one of the source and a second source, a future distance between at least one of the source and the second source, and a future time between the energy storage device moving by the source.

27. The apparatus of claim 21 wherein the one or more temporary circuits created through the energy storage device and the source while the energy storage device and the source are moving relative to one another is created in response to a contactless interaction between, at least in part, the energy storage device and the source.

28. The apparatus of claim 21 wherein the one or more temporary circuits created through the energy storage device and the source while the energy storage device and the source are moving relative to one another is created in response to a mechanical contact between, at least in part, the energy storage device and the source.

29. The apparatus of claim 21 further comprising a second energy storage device operatively connected to the energy storage device, wherein the second energy storage device is configured to automatically connect in at least one of series and parallel with the energy storage device when the energy storage device contains insufficient electrical energy to power a load.

30. The apparatus of claim 21 further comprising a switch configured to switch the energy storage device to match an impedance to a load in response to a slowing movement of the vehicle operatively connected to the energy storage device.
